(19) United States
(12) Patent Application Publication
(10) Pub. No.: US 2026/0073125 A1
(43) Pub. Date: Mar. 12, 2026

(54) APPARATUS, SYSTEM, AND METHOD FOR RECOGNIZED TEXT TRANSFORMATION IN AN ONLINE POSTING

(71) Applicant: Temple University-Of The Commonwealth System of Higher Education, Philadelphia, PA (US)

(72) Inventors: EDUARD DRAGUT, Bala Cynwyd, PA (US); Abdullah ALJEBREEN, Blue Bell, PA (US)

(21) Appl. No.: 19/251,980

(22) Filed: Jun. 27, 2025

Related U.S. Application Data
(60) Provisional application No. 63/665,286, filed on Jun. 28, 2024.

(51) Int. Cl. G06F 40/166; G06F 16/954; G06F 40/295

(52) U.S. Cl. CPC G06F 40/166; G06F 16/954; G06F 40/295

(57) ABSTRACT

An apparatus, system and method of entity/mention text transformation. The disclosure is and includes a computer readable medium storing non-transitory instructions that, when executed by a processor, cause the processor to perform operations including: recognizing entity text in an online posting comprising a plurality of substrings, wherein the plurality of substrings includes a subset of candidate strings, wherein the subset of candidate strings includes at least a first candidate string, and wherein the recognizing includes determining a first entity corresponding to the first candidate string; mapping the first entity to a first set of one or more prospective replacement texts; ranking the prospective replacement texts based on a plurality of weighted factors; and reconstructing the online posting, wherein the reconstructing includes replacing the first candidate string with a highly ranked one of the prospective replacement texts.

### CROSS-REFERENCE TO RELATED APPLICATIONS

This application claims priority to U.S. Provisional Application No. 63/665,286 filed on Jun. 28, 2024, incorporated herein by reference in its entirety.

### STATEMENT REGARDING FEDERALLY SPONSORED RESEARCH OR DEVELOPMENT

This invention was made with government support under 2137846 awarded by the National Science Foundation. The government has certain rights in the invention.

### BACKGROUND OF THE DISCLOSURE

The practical implementation of internally linking elements in social media posts, such as hashtags and user mentions, has become an integral usability feature across most social media platforms. These elements facilitate easy navigation, content discovery, and user interaction, thereby contributing to greater user participation.

As such, on social media platforms like X (formerly known as Twitter), users tend to place hashtags/tags/links around the main text of the post, i.e., before or after the post. Of course, users may also insert tags within the main text. That is, words and phrases referring to entities, places, events, and the like are substituted by an affirmative action of the user with hashtags/tags/links/mentions that are located by the user.

However, due to the fast-paced nature of social media, users often rush to create posts, leaving little time for consideration of hashtags, mentions, grammar or style. Consequently, users frequently misuse or misstate hashtags/tags/links/mentions/grammar/style, thereby weakening their messages or joining unrelated/unwanted conversations.

Hashtags are presently recommended to X users, in a “find and replace” manner, based on many aspects, such as their interests, followers, and past posts. One prevalent method involves temporal effect and content-based recommendation systems, in which algorithms analyze the post's text to suggest hashtags based on semantic similarities. Other inquiries include the context of the post, which includes other posts in the same conversation, to provide more effective recommendations.

Collaborative filtering uses user interactions and preferences to inform hashtag recommendations, allowing users to discover hashtags based on their interests and engagement with similar content. Furthermore, hybrid models combine multiple recommendation techniques, blending content-based and collaborative filtering approaches to deliver more personalized and accurate hashtag suggestions.

Other recommendation inquiries in X and like social media systems may consider multiple influencing factors, including user interests, spatiotemporal patterns, and geographical distribution. The main difference between in-line tag suggestion solutions and hashtag recommendation solutions is that in-line tag suggestions garner more attention because they are in-context, while hashtag recommendations are inserted at the end of a post, and thus corresponding to ongoing conversations, rather than being in-context to a particular post.

Additional previous “find and replace” tools also may merely suggest emojis when a message is typed on a mobile phone. Similarly, such as in a recent talk show effort on television, instead of saying a well-known person's name, a user may instead choose a synonymous appellation collected from a social media survey. However, in neither of these circumstances, nor in any of the foregoing known circumstances, are a variety of replacement options proposed and selectable in real-time. Nor do current editing tools recommend to users different objects, such as social media objects (SMOs) like hashtags, ‘at user’, images, or memes.

Similarly, many search engines also use hashtags and ‘at user’ to monitor/retrieve content from social media. However, typically, if a user needs to replace the name of personality with that personality's ‘at user,’ then the user needs to put in some effort to locate the correct/official one. This is even more tedious for hashtags, as there are thousands of similar hashtags, and including the wrong hashtag may change the meaning of the text and/or be detrimental to the user's intention.

Furthermore, writing assistance and style transformation may also implement replacement suggestions for errors, particularly in posts. For example, style transformation is converting text from one style to another while preserving the meaning. Simple synonym and phrase replacements may be used to enhance the stylistic features of a target corpus and achieve lexical simplification. Synonym replacements have been used particularly to improve the readability of medical texts, by way of example.

For example, and relatedly, a “Synonym” functionality is provided in Microsoft's Word (“MS Word”) offerings. Using this functionality, one selects a word and is provided a list of synonyms. This is distinct from the above examples at least in that, in this disclosure, the recognition of text for replacement is very limited, in the manner of an online dictionary, and need not be subjected to an analysis of temporal aspects, relevance aspects, or popularity aspects in the manner of a hashtag. For example, some hashtags increase or decrease in relevancy to particular terms over time, and/or become more or less popular than other hashtags in relation to certain terms, over time, unlike simple synonyms.

Other current “find and replace” efforts may handle out-of-vocabulary (OOV) words by either paraphrasing or replacing them with appropriate synonyms. Modern writing tools, such as Grammarly, have been introduced to assist end-users with their writing, including OOV words. Grammarly performs spell-checking and provides users with vocabulary choices to replace existing text that may be in error.

However, since many social media posts or microblog texts are typically short, noisy, and of a colloquial nature, Named Entity Recognition (NER) remains a tough task for Natural Language Processing (NLP) systems, especially for unconfined user spaces, such as social media posting (as contrasted from synonym replacement in the confined user space of formal writing). Put another way, this technical challenge of “find and replace” can be framed as large scale topical classification problem, wherein the set of topics is huge and highly dynamic, particularly in relation to social media posting.

As a general matter, almost all websites, including social media sites/apps, include a “Share” button that allows the user to select one or more social media platforms to which the user wants to post the generated message/content. For example, news websites allow users to share news articles. Once a user selects a social media platform to which to share, for example, the news article, an “Editor” may appear in a window with the initial (template) content. For example, for news outlets, this usually consists of the Title of the article, an image, or a passage from the article, or even the first paragraph or an abstract/summary of the article.

In such cases, many users use the Editor to edit the initial content, such as by replacing the proper name of a personality (including a person or organization) or place (country, city, event, or venue) with that personality's or that place's ‘at user’ or hashtags. Likewise, an entire subset of words may be edited and replaced with a hashtag related to a movement or event, like the #MeToo movement.

Similarly, when the title, paragraph, or abstract of content is lengthy, the user may rephrase it entirely, or merely parts of it, using the Editor. The reason behind such edits is to amplify the reach and directivity of posts, and to improve the ease of discoverability of posts among audiences interested in the topic. The disclosed replacement tool of the embodiments automates and enhances this observed editing behavior. That is, given a word or subset of words (i.e., a substring) in a draft post, the embodiments recognize text, recommend a list of potential replacements (such as in the form of social media objects (SMOs), such as hashtags, ‘at users’, images, or memes or even alternatives for the same substring, like synonyms, and provide an enhanced graphical user interface (GUI) experience to select one or more replacements from among the list of potential replacements.

### SUMMARY OF THE DISCLOSURE

The present disclosure relates generally to the transformations of entity text references, such as in social media and similar posts, which may be of a short, noisy, and colloquial nature, and more particularly, to an apparatus, system and method for transforming an entity text mention. Examples of the disclosure are set forth below, and any combination of these examples (or portions thereof) may be made to define any another example.

An apparatus, system and method of recognized mention/entity text transformation is described. More particularly, the disclosure is and includes a computer readable medium storing non-transitory instructions that, when executed by a processor, cause the processor to perform operations including: recognizing entity text in an online posting comprising a plurality of substrings, wherein the plurality of substrings includes a subset of candidate strings, wherein the subset of candidate strings includes at least a first candidate string, and wherein the recognizing includes determining a first entity corresponding to the first candidate string; mapping the first entity to a first set of one or more prospective replacement texts; ranking the prospective replacement texts based on a plurality of weighted factors; and reconstructing the online posting, wherein the reconstructing includes replacing the first candidate string with a highly ranked one of the prospective replacement texts.

In one case, the replacing the first candidate string may include manual replacing, and prior to the manual replacing: displaying a selectable panel comprising the first set of one or more prospective replacement texts corresponding to the first candidate string; and receiving a user selection of the highly ranked one of the one or more prospective replacement texts from the selectable panel.

In one case, the subset of candidate strings further may include a second candidate string; wherein the recognizing may further include determining a second entity corresponding to the second candidate string; wherein mapping may further include mapping the second entity to a second set of one or more prospective replacement texts; and wherein reconstructing may further include automatically replacing the second candidate string with a second prospective replacement texts of the second set of one or more prospective replacement texts.

In one case, automatically replacing the second candidate string may not include displaying.

In one case, the replacing the first candidate string may include automatic replacing.

In one case, the recognizing may include an entity detector to determine the first entity, wherein the entity detector may include an encoder to determine the first entity.

In one case, the encoder to determine the first entity may include a bidirectional encoder.

In one case, the recognizing may include an entity detector to determine the first entity, wherein the entity detector includes named entity recognition to determine the first entity.

In one case, mapping the first entity to a first set of one or more prospective replacement texts may include a character level algorithm.

In one case, the character level algorithm may include a character-level N-grams TF-IDF algorithm.

In one case, mapping the first entity to a first set of one or more prospective replacement texts may include a hybrid retrieval.

In one case, the hybrid retrieval may include a bag-of-words retrieval function.

In one case, the hybrid retrieval may include nearest-neighbor search associated with the entities.

In one case, the nearest-neighbor search may be associated with a number (k), wherein the number (k) of the nearest-neighbor search sets the one or more prospective replacement texts.

### BRIEF DESCRIPTION OF THE DRAWINGS

The foregoing purposes and features, as well as other purposes and features, will become apparent with reference to the description and accompanying figures below, which are included to provide an understanding of the disclosure and constitute a part of the specification, in which like numerals represent like elements, and in which:

FIG. 1 depicts one aspect showing an exemplary replacement tool.

FIG. 2 depicts one aspect showing an exemplary flowchart for microblog text transformation.

FIG. 3A and FIG. 3B depict another aspect showing microblog text transformation.

FIG. 4A depicts another aspect showing an exemplary flowchart for data flow for microblog text transformation.

FIG. 4B depicts another aspect showing an exemplary flowchart for data flow for microblog text transformation.

FIG. 5A depicts another aspect showing an exemplary flowchart for transforming microblog text.

FIG. 5B depicts another aspect showing an exemplary template of exemplary microblog text.

FIG. 5C depicts another aspect showing exemplary methods for transforming microblog text.

FIG. 6 depicts another aspect showing an exemplary computing device.

### DETAILED DESCRIPTION OF THE DISCLOSURE

It is to be understood that the figures and descriptions of the present disclosure have been simplified to illustrate elements that are relevant for a clearer comprehension of the present disclosure, while eliminating, for the purpose of clarity, many other elements found in systems and methods. Those of ordinary skill in the art may recognize that other elements and/or steps are desirable and/or required in implementing the present disclosure. However, because such elements and steps are well known in the art, and because they do not facilitate a better understanding of the present disclosure, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this technical subject matter belongs. Although any methods and materials similar or equivalent to those described herein can be used in the practice or testing of the present disclosure, exemplary methods and materials are described.

As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred or required order of performance. It is also to be understood that additional or alternative steps may be employed, in place of or in conjunction with the disclosed aspects.

“About” as used herein when referring to a measurable value such as an amount, a temporal duration, and the like, is meant to encompass variations of ±20%, ±10%, ±5%, ±1%, and ±0.1% from the specified value, as such variations are appropriate. Further, throughout this disclosure various aspects of the disclosure can be presented in a range format. It should be understood that the description in range format is merely for convenience and brevity and should not be construed as an inflexible limitation on the scope of the disclosure. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Using the embodiments, social media users may enhance the content of posts with in-line editing/addition suggestions before posting, such as on social media platforms, such as X (formally Twitter), Facebook, Reddit, and LinkedIn, by way of non-limiting example. Aspects of the embodiments facilitate at least edits comprising: replacement of a word or a subset of words (i.e., substring) with a typical social media object (SMO), like a hashtag, user handle, image, or meme; replacement of a word or subset of words with a content and/or network link; replacement of a word or subset of words with proprietary content, such as photos, emojis, gifs, or original produced content; and replacement of word or subset of words with combinations of the foregoing.

The disclosed replacement tool disclosed may employ Named Entity Recognition (NER) and/or Entity Linking (EL), by way of non-limiting example, to recognize the word or subset for replacement. The embodiments may also include systems and methods to develop ranked recommendations of possible replacements of the recognized text in the original post with the corresponding replacement content, such as the replacement SMO.

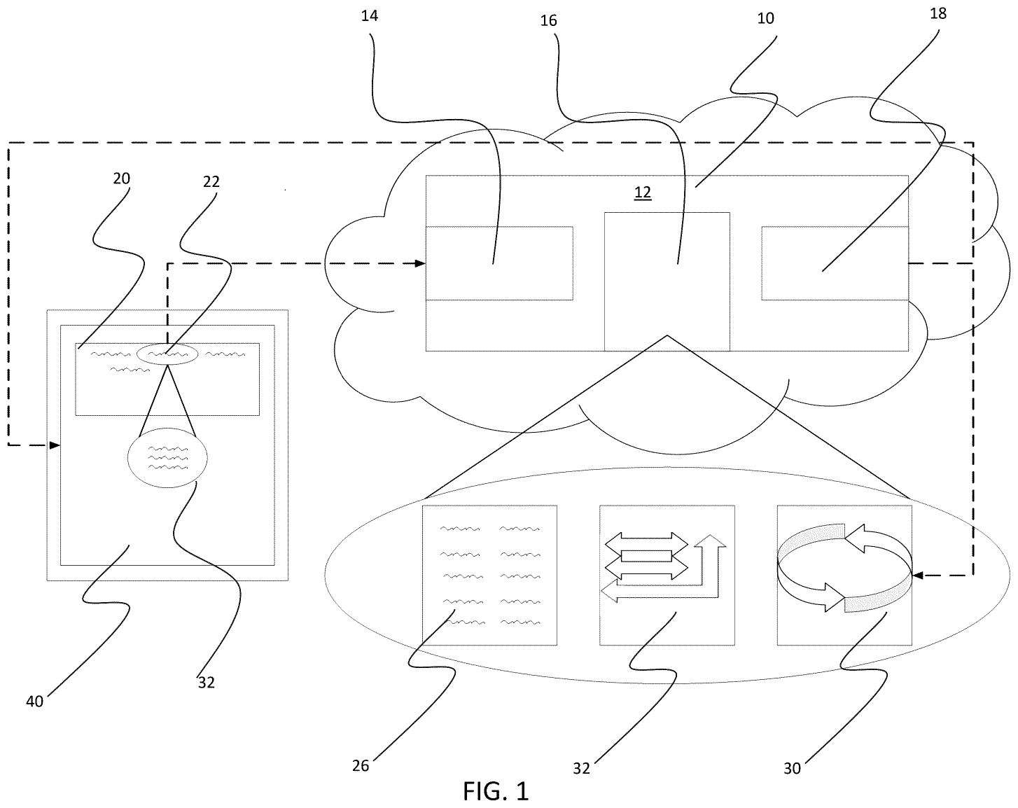

By way of example and as illustrated in FIG. 1, the disclosed replacement tool 10 may be provided as an add-on, widget, app, a licensable piece of software such as a library, or the like, such as a browser or site add-on. The tool may execute an algorithm 12 having recognition 14, replacement 16, and presentation 18 modules.

The recognition module of the replacement tool starts by detecting a post draft on a page 20. If one is present, the recognition module employs a model, such as a NER model, to identify entity mentions 22 within the post. The entities within draft posts may range from individuals and locations to events, concepts, belief systems, movements and organizations. For example, the algorithm first detects a draft post on a page (such as in a browser or on an app). If a draft is present, the recognition module employs a model, such as a NER model, to identify substrings (e.g., entity mentions like The President or The First Lady) within the post. The applied module requires a deep natural language understanding of the text, such as recognizing that a subset of words may denote an entity or place (like a person, location, organization, building, or event), or a concept (poetry, political judgement, movement support, etc.), by way of example.

The recognition module is complemented by the replacement module 16, which engages in robust entity linking 26 that associates these recognized entities with relevant/popular/timely tags/links and ensures the replacements generated align with the contextual meanings of the recognized text. The replacement module also employs heuristics and feedback 30 based on user behavior patterns, such as may occur from directives given via presentation module 18, to dynamically generate new and increasingly contextually appropriate replacements.

More specifically, the replacement module assesses, based on recognition of text by the recognition module, a list of possible replacements 32 of the recognized text. The list of possible replacements may be ranked by leveraging a constantly-updated knowledge base and an existing repository of SMOs. The rankings may be created by applying a layered algorithm, such as may use machine learning/artificial intelligence and continuous feedback in its ranking of possible replacements. For example, a category may first be identified for the recognized text. Upon identification of the category, a particular replacement-generating algorithm 26, 30, 32 for that category may be implemented. Thereby, the replacement algorithm establishes connections between recognized entities, places, and concepts with potential replacements, such as SMOs, using a confidence score/rank assigned to each replacement, such as each to each hashtag or link.

That is, by leveraging a constantly updated knowledge base and an existing repository of hashtags/tags/links/mentions, the replacement module establishes connections between recognized entities and potential replacement candidates, along with a confidence score/rank assigned to each prospective replacement. Additionally, the replacement module may generate new relevant hashtags to be added as replacement candidates, as discussed further below. The ranking algorithm may generate a ranked list unique to each entity, and may vary based on category of recognized text, by way of example.

Yet more specifically, the list of candidate replacements may be ranked based at least on relevance, and may use a weighted algorithm of a number of factors. The selected factors may vary by category of the recognized text, and the weighting of factors may also vary over time based on the heuristics and feedback discussed throughout.

Finally, the presentation module 18, such as via a GUI 40, may allow the user to direct, or may automatically establish, a reconstruct of the original post by replacing recognized entities with one or more selected replacement hashtags/tags/links/mentions. Users may experiment with different replacements for each entity, regenerate a modified post for different selected replacement(s), and/or roll back to the original draft, via the GUI. Once a user is satisfied with the modified post, it may be posted and/or inserted back into the draft box.

That is, the GUI provided by the presentation module may provide optionality in the manner in which the prospective replacements are presented, and particularly in the manner in which the ranking thereof is indicated to and/or selectable by the user. Moreover, the GUI may provide the user a choice between manually choosing the preferred replacement from the list of candidate replacements, or using the replacement tool to automatically perform the replacements using the “best-available.” As referenced, the presentation module may generate a rewrite of the initial post, incorporating the selected replacement(s).

Simply put, the replacement tool 10, either automatically upon selection of the best replacement or upon choice of a user through a GUI, reconstructs the original post by replacing entities with the corresponding/selected replacements, such as the selected SMOs, thus increasing the post's engagement potential. Experimentation with different replacements for each entity, regeneration of the modified post, or rolling back to an original draft, if desired, may also be enabled by the GUI of the presentation module. Once a user is satisfied with the modified post, it can be inserted back into a draft box. In addition, suggested replacements can be organized/suggested in a certain manner, like humorous, topical, professional, official, or trendy, by way of non-limiting example.

The replacement tool may assist users with composing mention-rich posts effortlessly, either as a standalone feature or as an easily-incorporated website add-on that supports “share and edit” tools, like news websites. Indeed, posts utilizing hashtags within the main text frequently incorporate shared URLs, such as URLs for articles that point to websites that offer the aforementioned sharing button functionality, which allows users to post the URL directly to their accounts. The prevalence of shared URLs within posts with mentions suggests that users leverage hashtags to clarify the URL content and augment the depth of the post. For example, users frequently mention entities from the URL in their accompanying commentary or discussions to provide additional context to the linked content.

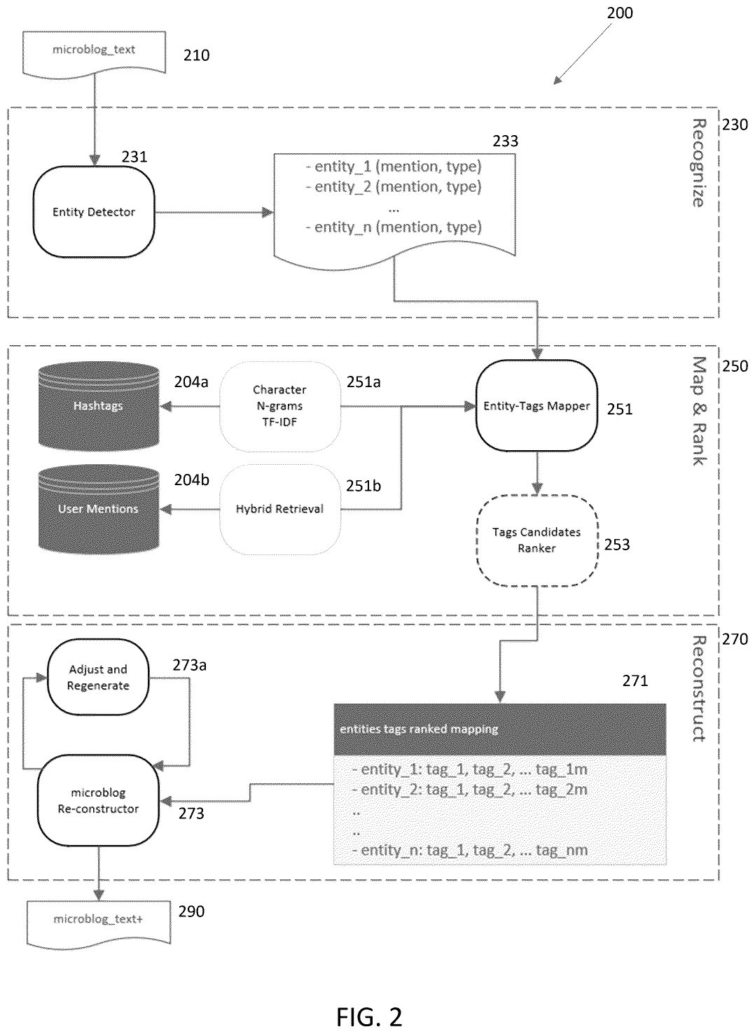

FIG. 2 shows the main steps of a method performed by the modules of the replacement tool, namely recognition, mapping of replacements, and selection/reconstruction/posting, which correspond to the recognition, replacement and presentation modules discussed hereinabove. In the first step, candidate substrings are found and recognized that may be subject to replacement. The recognized candidates are the named entity/location/movement/event mentions within a draft post.

Due to the short, noisy, and colloquial nature of posts in particular, NER is complex for an NLP system. In addition, detecting all mentions of entities from diverse yet constrained contexts in concise posts is challenging. To tackle these challenges and enhance the generalization and robustness of the recognition module, an NER Globalizer model may be followed.

In the NER Globalizer execution cycle, a pre-trained BERT encoder may be employed in the Local NER step to process the post sentence-by-sentence, extracting strings in which recognition candidates appear (known as candidate surface forms). The token-level outputs may be stored as “entity-aware token embeddings,” i.e., as having a possibly recognizable (and thus replaceable) entity therein.

In the next step, all mentions of seed candidate surface forms may be extracted, and contextual embeddings may be generated based on the context of the post. The classification of entity types considers context-dependent surface forms, resolving ambiguity through optimal clustering. Local contextual embeddings may be aggregated to create global embeddings for entity candidates, which are then classified using an entity classifier. The final NER outputs include mentions of candidates labeled as entity types, along with their corresponding classifications.

Once the entities/locations/movements/mentions are recognized by the recognition module, each recognized entity is mapped by the replacement module to a ranking of its related hashtags/tags/potential existing at-users (i.e., entity hashtags map and entity-user map)/links. These mapped potential replacements may be gained by, for example, a general or targeted (to certain web sites) web crawl, wherein the information provided via the crawl may include information on any number of “factors,” such as popularity, frequency, relevance, temporal factors, traffic factors, referrals to/from, followers, and the like.

Thereafter, the replacement module extracts the highest rated prospective replacements, such as the most frequent and/or popular hashtags and/or user mentions from this dataset, which may be limited by a minimum occurrence and/or temporal threshold, such as a minimum occurrence of 10 times and/or a minimum existence of 48 hours.

Regarding these “factor” ratings, the replacement module may leverage one or more site's, such as X's, API to obtain factor data, such as data regarding user account, traffic, embedded information, descriptions, etc. On this data, too, collection restrictions may be placed to add to processing efficiencies, such as limiting site-data leveraging, and/or replacement seeking upon recognition, only to those entities/mentions that meet a predetermined use-frequency threshold, such as entities with a mention-frequency of 100 or more. Likewise, the replacement-seeking functionality may be limited by user-account, such as only to users who pay a fee and/or users who meet a minimum content contribution, i.e., posting, threshold.

Using short text matching for the entity-replacements map, character-level n-grams TF-IDF algorithm may be leveraged to find the top-k most relevant replacements from the possible replacements dataset. To build an entity/mention-per-user map, built-in hybrid retrieval may be utilized, which combines the results of sparse retrieval of entity and user names, and the results of dense retrieval between post content and a user's profile. The outcome of this step may be that each recognized entity has a list of top-k potential replacements, such as hashtags, tags, links, memes, and/or users.

In addition to mapping entities to, for example, existing hashtags (or tags, links, mentions, memes, etc.), the replacement module may use user patterns to generate new hashtags. This step may be performed when the entities do not have corresponding hashtags in the knowledge base. Drawing insights from a continuously updating analysis of popular hashtags, such as the 100 most popular hashtags at a given time, the replacement module may generate on-demand new hashtags from entities.

By leveraging a learn-to-rank framework, suggestions associated with each entity within a post are ranked. The model involves initial training using a dataset, followed by feedback on user choices for replacements, heuristics on evolving relationships between entities and hashtags/tags/links/mentions, and considerations of the contextual nuances provided by the post's content. By employing this feedback-driven framework, the precision, quality, and relevance of suggested replacements is continuously enhanced.

The presentation module presents the user with the list of ranked replacements. Any of a myriad of presentations may be made, and the presentation type may or may not convey information on the rankings to the user via the display. By way of example, the replacements may be provided in a simple list, with the highest ranked prospective replacement at the top of the list, or visual cues may be provided to the user to convey the rankings. For example, a series of bubbles of decreasing size may be provided clockwise around each recognized entity upon a “cursor-over,” with the largest graphical bubbles being indicative of the highest ranked prospective replacement, the next largest bubble indicative of the next highest ranked prospective replacement, and so on.

With the entities mapped to a ranked set of possible replacements, and upon either a manual or an automated selection of a preferred replacement, the presentation module proceeds to reconstruct the post. That is, it replaces each recognized entity within the post text with the top/selected replacement. The user has the option to review and revise the edits to the original draft post, and/or to choose a different replacement. For example, the user can click on or hover over a highlighted recognized substring having an initial replacement, and the presentation module may provide anew, such as via a drop-down list, other ranked possible replacements.

Specifically, again in relation to FIG. 2, shown is a method 200 for transforming recognized text (such as microblog_text as shown) 210 to replacement text (microblog_text+) 290, as executed by replacement tool 10. The method includes at least the steps of recognizing 230 by the recognition module, mapping and ranking the recognized text 250 by the replacement module, and interfacing with the user to reconstruct the post using replacement text at 270 by the presentation module.

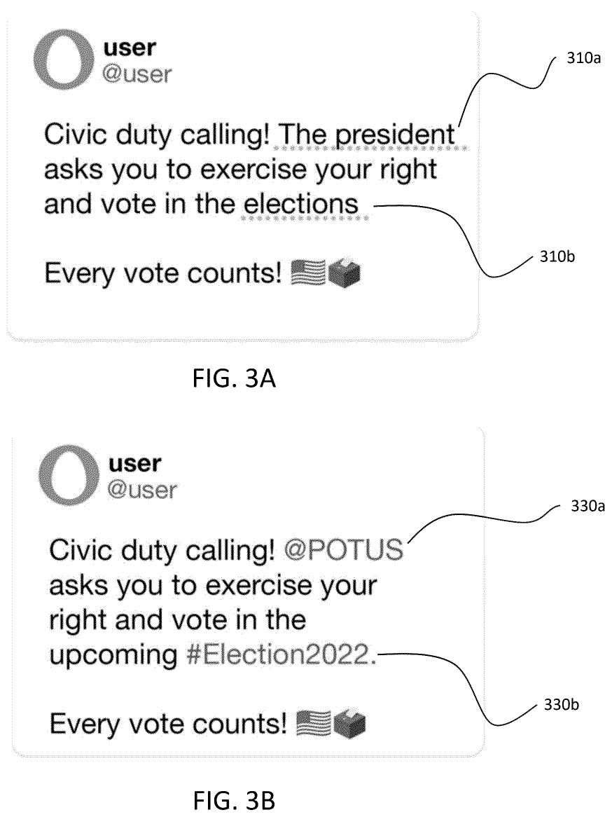

FIGS. 3A and 3B show a post both before, (A), and after, (B), applying the concept of replacing entities with a relevant hashtag/tag/link/mention, as detailed in FIG. 2. For example, a mention of “the President” may be affirmatively replaced by the user with @POTUS, #Biden, @JoeBiden, or with a CNN news link, among other options.

More particularly and with reference now to the illustrations of both FIG. 2 and FIG. 3, recognizing step 230 recognizes/highlights candidate text substrings 310a and 310b for eventual replacement. Candidate substrings may be replaced with replacement text 330a and 330b (as is also shown in FIG. 3). Candidate text may also be referred to throughout this disclosure as a recognized entity mention, such as the microblog_text 210. In the case of social media, by way of particular non-limiting example, microblog text 210 may include a draft of a post having therein recognizable candidate text.

Detecting all recognizable mentions of entities in the microblog_text (e.g., social media post) may be challenging due to the diverse but constrained set of contexts, along with the noisy and informal language frequently used in social media posts. To tackle these challenges and enhance generalization and robustness of entity detector 231 of the recognition module, entity detector 231 may comprise the NER Globalizer model, which is well-suited for detecting named entities. This is shown by way of example as 310a in the case of the “President”.

As referenced above, in a NER Globalizer execution cycle, a pre-trained BERT encoder may be employed in the Local NER step to process microblog text 210 sentence-by-sentence, extracting strings in which candidates appear. The token-level outputs are stored. All mentions of seed candidate surface forms are extracted, and contextual embeddings are generated based on the context of the post. The classification of entity types considers context-dependent candidates, resolving ambiguity through optimal clustering. Local contextual embeddings are aggregated to create global embeddings for entity candidates, which are then classified using an entity classifier.

The final NER outputs 233 may include mentions of candidates labeled as entity types along with their corresponding classifications. Named entity types may include categories such as ‘where,’ ‘what,’ ‘who,’ or ‘when.’ Examples of types may comprise Person, Organization, Location, Movement, Hot Topic, Products, Works of Art, Dates, Percents, Quantities, Money, Ordinal numbers, Cardinal numbers, and so on, by way of non-limiting example.

Once entities/mentions are recognized, each entity may be mapped by the replacement module to an object within one or more datastores (e.g., 204a, 204b, etc.) using entity-mention mapper 251. By way of example, datastores 204 may include but are not limited to datatypes such as integers, floating-points, strings, characters, dates, Booleans, struts, objects, etc. In the specific case of social media, the multiple types may include social media objects (SMO), such as hashtags (e.g., #MeToo), user handles, images, memes, etc.

In one or more cases, multiple datatypes or SMOs may be mapped using N-grams TF-IDF or hybrid retrieval. In the case of hashtags, the character-level N-grams TF-IDF algorithm may be used for the mapping process as depicted in FIG. 2. For example, the character-level n-grams TF-IDF algorithm may be used to find the top-k most relevant hashtags from our hashtags dataset or similar datatype.

In the case of user handles or user mentions, hybrid retrieval 251b may be used for the mapping process, as depicted in FIG. 2. Hybrid retrieval 251b may comprise the results of sparse retrieval (e.g., BM25 scoring using bag-of-words representations) of entity and usernames, and the results of dense retrieval (e.g., nearest-neighbor search on transformer-encoded representations) between post content and a user's profile. The outcome of this step is each recognized entity has a list of top-k potential hashtags and users.

Referring now again to FIG. 2, shown are datastores 204, which act as a knowledge bases that may be constantly updated. Each of the datastores 204a, 204b, etc., may be populated by extracting datatypes from websites or the internet. In the case of social media, extracting datatypes may be based on social media websites, such as extracting likes, hashtags, or user mentions. In any case, extracting may comprise web scraping (e.g., extracting data fields) and/or web crawling (e.g., finding URLs and indexing). Alternatively, or additionally, the datastores 204a, 204b, etc., may be populated using APIs to obtain/extract the desired datatypes from websites. In the case of social media, an API may be used to obtain user account descriptions from social media to populate a datastore associated with user mentions or user handles, by way of example. Additionally, extracting may further comprise filtering by applying a threshold operator 10, 100, or 1000 times the minimum occurrence of the at least one datatype, by way of non-limiting example.

In cases in which entities do not have existing hashtags upon the datatype extraction, an analysis of user patterns may be used to generate new hashtags. For example, a selection of popular hashtags may be chosen (e.g., 100), wherein each may be linked to a specific entity, and a comparison to the mention of the current entity may be contextually compared. Drawing insights from this analysis, a new hashtag may be generated.

After entities/mentions have been mapped in using Entity Mapper 251 of the replacement module, the possible replacements may be ranked by one or more algorithms using Replacement Candidate Ranker 253. The ranking may return a relevancy score or confidence score for each replacement. Additionally, the ranking may be based on a certain additional factors, such as a context score, a political score, a humor score, a “hot topic” score, an official score, and/or trendy score, by way of non-limiting example.

By way of non-limiting example, the Ranker may first assess a category and/or subcategory of the recognized text. By way of example, the recognized text regarding an NFL quarterback may first be recognized as a Famous Person, with the subcategory of Athlete. The factors for this category/subcategory may be, solely by way of non-limiting example, relevance at a 50% weighting, popularity at a 30% weighting, and recency at a 20% weighting.

For the relevance weighting, the replacement module may review any number of elements, including precise repetition of full name, correct statement of player's team and sport, where the mention is provided, and so on. For the popularity weighting, numerous elements may be employed, such as number of followers for the NFL quarterback or of a posting entity, number of likes of a link or post, number of hits on a linked article/page/site, and so on. Of course, the embodiments also may offer a popularity element unavailable in the known art or to the human mind, which is the ranking of the most popular replacement(s) selected across tens, hundreds, or thousands of users, uniquely available in the embodiments in real time due to broad deployment of the replacement tool. Finally, the recency weighting, solely by way of non-limiting example, may provide maximum weight to postings over the last 24 hours, then weight to posts in the last 25-72 hours, and so on.

In this example in relation to the NFL quarterback, six (6) possible replacements may be returned—two hashtags, two social media postings, and two news articles. It should be noted that, with respect to the example which follows, although only one or two elements may be mentioned for each factor's scoring, this is done herein solely for brevity, and far greater numbers of elements may be used to score each factor, although it should be noted that the elements should be applied consistently across prospective replacements.

Specifically with regard to the example herein, for the two hashtags, one mention may be specific to the quarterback's name and team, the other may be solely the quarterback's last name and his prior team. On a 1-5 relevance scale used solely by way of example, the first of these hashtags may thus receive a 5, and the second may thus receive a 3. For the two social media postings, the first may be the account of a national newscaster, and the context may indicate the post refers to a recent game; the second may be the account of the quarterback's mother, and the context may indicate that his mother is calling him a “very sweet boy.” On the same 1-5 scale, the first posting may thus receive a 5, while the latter social media posting receives a 1. Finally, for the two news articles, the first may be on a national sports channel's website and may include the quarterback's full name with the context of a recent game, while the second article is on a site local to where the quarterback's team is situated, and the context may indicate interest by the quarterback in collecting sports cards. As such, the first article may receive a score of 5, and, particularly if the current draft post in which the quarterback's name was recognized involves the recent game, the second article receives a score of 2 for relevance.

As to popularity, in relation to the two hashtags, the first hashtag may, among other information, be the replacement choice selected by 85% of other users of the replacement tool, and thus may score a 5, while the second hashtag is associated with an account having only 3 followers, and thus gets a score of 1. For the two social media postings, the first mention's account may have 100,000 followers, and may thus receive a score of 4, and the second may have over 10,000 likes, and may thus also receive a 4. For the two articles, one may be on a website that receives 25,000 daily hits, and the second may receive 250 daily hits, and thus these sites may receive popularity scores of 4 and 1, respectively.

Finally, for recency, the elements above may be applied, namely the number of hours since the mention occurred. Pursuant to this scoring for the example above, the two hashtags may score a 4 and a 1, respectively; the social media postings may score a 4 and a 5, respectively, and the articles may score a 4 and a 5, respectively.

Once scores are made, the weighting of the factors for this category, such as set forth in the exemplary ratios above, may be applied. Accordingly, the first hashtag received scores of 5, 5 and 4, for a total score after weighting of 4.8; the second hashtag received scores of 3, 1 and 1, for a total score after weighting of 2.0; the first social media posting received scores of 5, 4, and 4, for a total score after weighting of 4.5; the second social media posting received scores of 1, 4 and 5, for a total weighted score of 2.7; the first link/article scored 5, 4, and 4, for a total weighted score of 4.5; and the second link/article received scores of 2, 1, and 5, for a total score after weighting of 2.3. Thus, the rankings for the recommended replacements will be, in order: the first hashtag; the first social media post; the first link/article; the second social media posting; the second link/article; and the second hashtag.

By way of further example, Replacement Candidate Ranker 253 may include a learning-to rank framework which involves ranking suggestions associated with each recognized entity within a post. This approach involves initially training a model that continuously learns the relationships between entities and hashtags/tags/mentions/links, including consideration of the contextual nuances indicated, at least in part, by the post's content.

With the recognized entities mapped to a ranked set of replacement suggestions, the method proceeds to reconstruct and/or present the options to reconstruct the microblog_text to microblog_text+, per FIG. 2, via the presentation module. In an exemplary case, for each recognized entity within the microblog_text, the top ranked replacement may be automatically chosen by the replacement tool. For example, entity_1 within the microblog_text may be replaced with tag_1 to create microblog_text+, wherein tag_1 was ranked as the highest ranked prospective replacement with the most relevant ranked score or the highest confidence score. In this case, the user need not select the replacement from the ranked list, and the replacement may be done automatically.

Alternatively, or additionally, for each recognized entity, the user may click or otherwise select any of the ranked replacements, which may have been sorted by ranker 253. After the selection, the recognized entity may be replaced with the selected ranked replacement. The user may perform this operation repeatedly for each recognized entity until all the recognized entities have been manually replaced.

It will additionally be appreciated from the instant disclosure that some of the recognized entities may be replaced by manual selection, and some by automatic selection. By way of example, hashtags may automatically be inserted to replace certain recognized entities having hashtags, whereas the other recognized entities/mentions not having hashtags may cause to be presented to the user a series of ranked replacements consisting of links/mentions which are manually selectable by the user. Of course, any other reasoning for some automated replacements, and some manual replacements, may be used by the replacement tool.

Relatedly, the user may specify, such as within user settings of the app or add-on with which the replacement tool is associated, which types of entities/mentions may automatically be replaced, and which types of entities/mentions may be manually replaced. In the case of automatic replacement, it goes without saying that the user may undo the automatic replacement (e.g., for example the replacement that was top-ranked as the replacement with the best confidence score), and may instead select a new or different replacement, such as a lower-ranked replacement having a lower confidence score.

By way of example, the method 200 may be implemented, in whole or in part, using a browser add-on/plugin or an application, i.e., an “app”, on a computing device, as discussed herein throughout. In addition to the manner or operation detailed hereinabove, the user may alternatively copy and paste information from a draft post, such as from an app or from a website, or the like, into the replacement tool resident in the browser plugin or application.

Thereafter, replacement tool may generate the replacement text (i.e., microblog_text+290) via method 200 as detailed above, and the user may copy and paste the modified text back into the app/website.

For example, when a user is drafting microblog_text in the form of, for example, a tweet, social media post, reddit post, or any other type of text box for posting microblog-text, the browser plugin may detect the drafting of the microblog_text. Then the replacement tool may suggest that the draft post be pasted into the replacement tool, or the replacement tool may automatically “see the text,” such that the entity detector 231 may identify entity mentions (i.e., people, places, events, topics, etc.) within the post. As mentioned herein, a NER model may be used by the entity detector 231.

Leveraging the constantly updated knowledge base and/or the existing repository allows for the browser to establish connections between recognized entities and potential replacement candidates using the mapper 251, and then assign a ranking score to each possible replacement tag/hashtag/link/mention. Moreover, the constantly updated knowledge base is large and dynamic due, in part, to the large datastore, i.e., so-called big-data, generated from web scraping, for example, or a like-datastore gathering algorithm 251 employed.

As mentioned, the replacement tool may also generate new relevant hashtags to be added as replacement candidates when a hashtag is not mapped in datastore 204a by mapper 251 to the recognized entity. The ranking algorithm 253 is applied to all possible replacements generated, including to newly generated hashtags, to generate the ranked replacements list for each recognized entity.

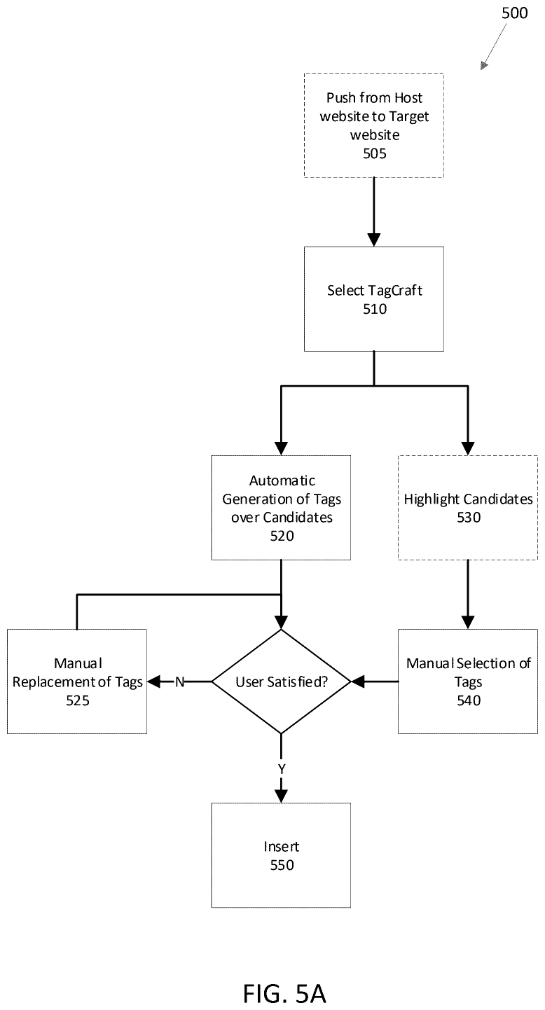

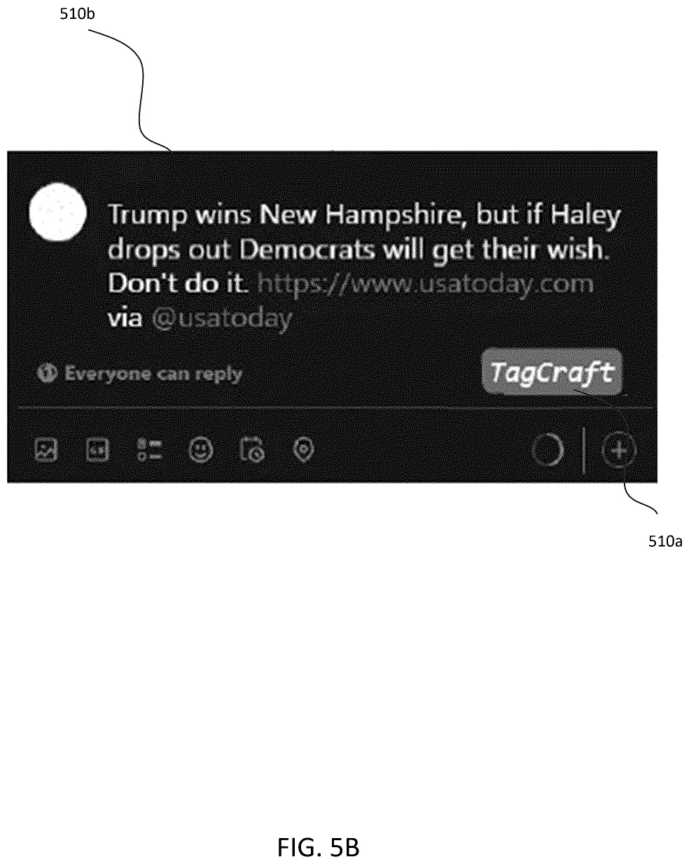

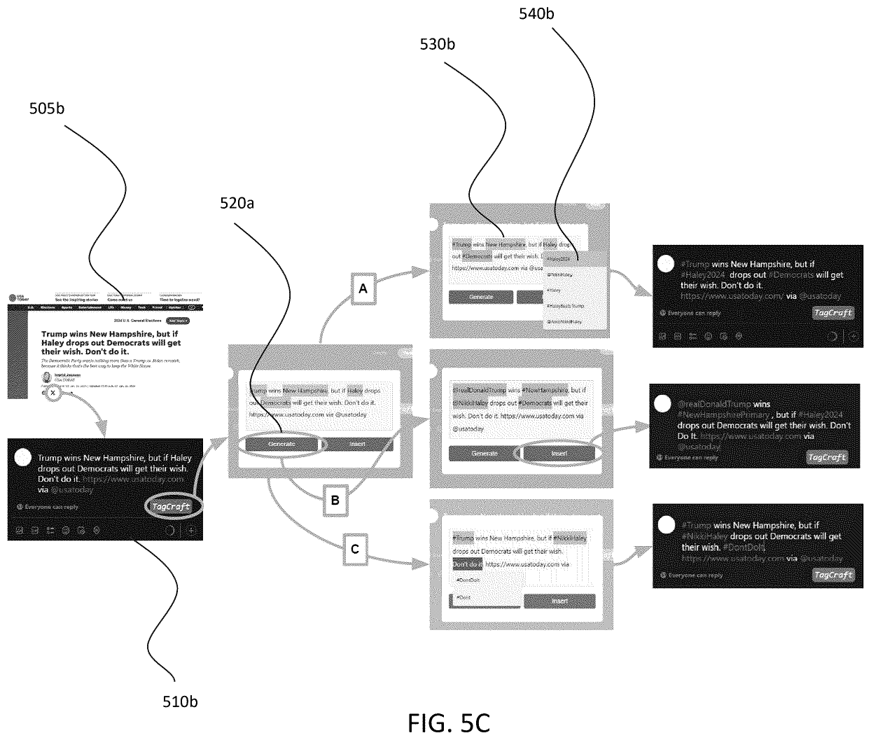

Finally, per method 200, the replacement constructs the post, now including the selected replacement, i.e., microblog_text+, by replacing the recognized entities with the selected replacements, i.e., the selected hashtag, newly generated hashtag, user mention, link, hyperlink, SMO, or the like. The selection of the replacement, when done manually, may be performed using a dropdown box, a selection panel, a selectable list, or other GUI item that displays one or more options (as shown by example in FIG. 5C).

By way of example, the selectable replacements may be sized, shaped, or colored so as to indicate their respective ranking with respect to one another. Moreover, the selectable replacements may be presented proximate to the recognized text for replacement in a manner that readily allows for their selection, and that accounts for their size and shape. Yet further, the replacements, in the course of this presentation, may include data in their respective presentation that is otherwise indicative of their respective ranking. For example, and as referenced herein, prospective replacements may be presented in a plurality of bubbles clockwise around the recognized text for replacement, wherein the bubbles vary in size from largest, representing the highest ranked replacement, to the smallest, representing the lowest ranked suggested replacement. These bubbles may also be colored, i.e., green bubbles have a greater than 50% relevance ranking in relation to the recognized text, yellow bubbles have a 25%-49% relevance to the recognized text, and red bubbles have less than a 24% relevance to the recognized text, and/or may include data within the bubble (i.e., the actual numeric relevance in the exemplary embodiment detailed above).

Users may experiment with different replacements for each entity, regenerate the modified post, or roll back to the original draft, if desired, any number of times in a loop using the adjust and regenerate 273a feature of the presentation tool. In one or more cases, the user may use adjust and regenerate 273a in an application on the host computer, and when the user is satisfied with the microblog_text+, the user may copy/paste the text back into the same or another application (e.g., web application in a browser).

The vast majority of news outlets offer a “Share” capability for readers who want to post the article on their social media accounts. Typically, upon clicking the “Share” button, a draft box appears, presenting users with a pre-populated, default text that typically contains the article title, the URL, and some excerpt.

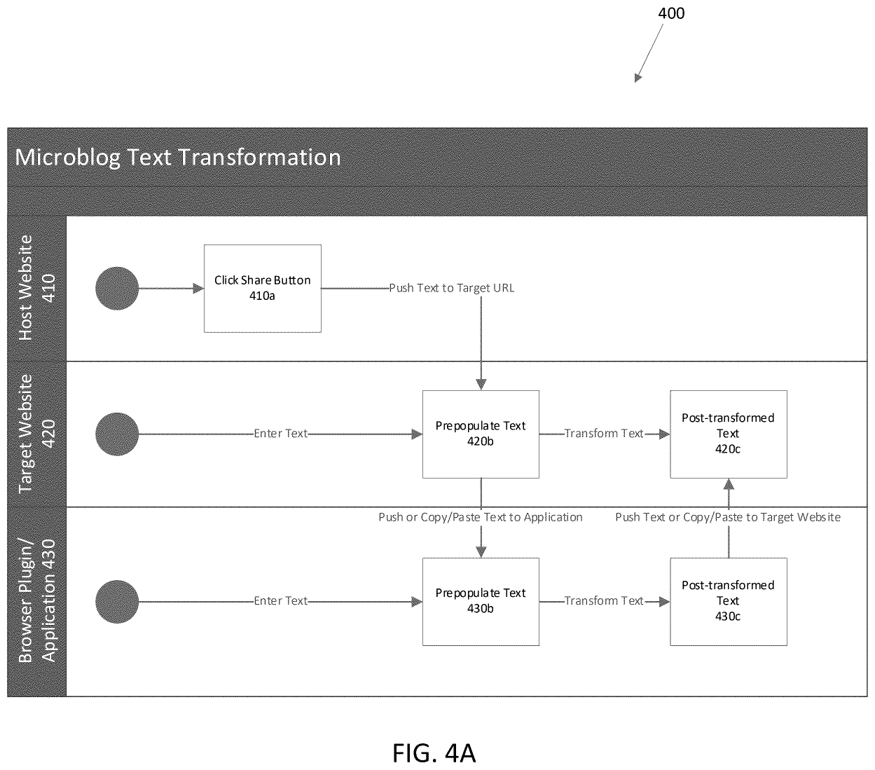

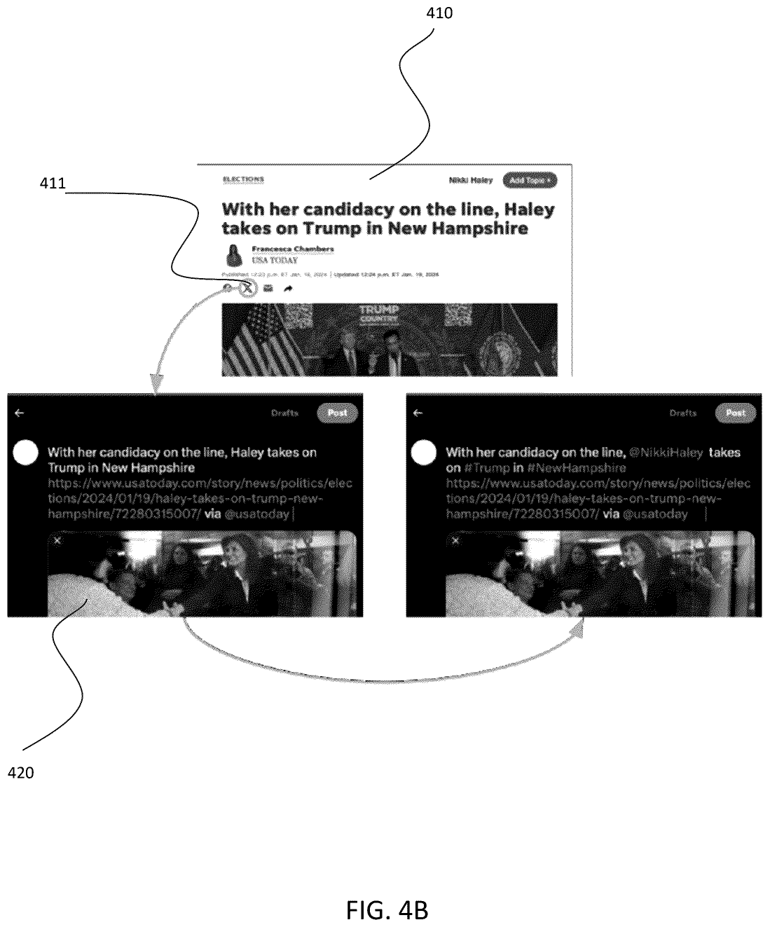

Users routinely edit the default text by replacing entity mentions with corresponding hashtags/tags/links/memes, etc. For example, minor edits to the title of a hyperlinked social media post are common in X (Twitter). This showcases a noteworthy trend in which users edit their posts to increase engagement and visibility. FIG. 4 illustrate screenshots of an exemplary “Share”and edit post.

By integrating the replacement tool into the post-composition workflow for this “Sharing,” the user's ability to craft posts that are better connected to an ongoing topic/event is appreciably enhanced. This ultimately contributes to a more engaging and interconnected social media experience.

More specifically, FIG. 4A is an exemplary flow diagram for recognized text replacement. A user may push text from a host website 410 (e.g., a news website) to a target website 420, or may “share” with the app/plug-in/target site, such as by clicking a “Share” or like-button in step 410a (an exemplary button is shown as element 411 of FIG. 4B). Upon sharing, a template of the pushed text may be created on the target website, as shown in FIG. 4B. Using this template, text processing may take place on the target website 420 (e.g., social media), or in another case, to be further pushed to browser plugin/application 430 to be processed. The template may also include the title of article, an image, a passage, or one or more parts of the article (such as the first paragraph).

Additionally, and alternatively, the user may prepopulate text by entering text (e.g., typing or copy/pasting) into a prompt at the target website 420. After the text has been populated, the text may automatically or manually transform into selected replacement text 420c, as discussed throughout. Alternatively, selected replacement text 430c may be pushed or copy/pasted into the target website 420.

Referring now to FIG. 5, FIG. 5A shows an exemplary flowchart for transforming/replacing recognized text (aka, microblog text). The method may start by pushing recognized text from the host website to the target website in step 505, or as noted above, the user may enter the text directly to target website 420 in FIG. 4A. When the text is pushed to the website, or when a user has entered text into a prompt of a target website (e.g., social media), the user may click a button to replace/transform in step 510. This button may be located in or on the exemplary text prompt 510b, as shown by example in 510a of FIG. 5B, or elsewhere as will be understood to the skilled artisan. Moreover, it can be appreciated by a skilled artisan that after the text is pushed in step 505 in the form of a template, the user may edit the text if the initial text is too long for the receiving template, and/or may rephrase by shortening the text in a case of a post (e.g., social media such as Twitter or Facebook).

There may be an automatic generation and/or selection of replacement text over the recognized candidates in step 520, and in another case, and/or there may be a manual selection of replacement text in step 540, with an optional highlighting of candidate replacements in step 530 (and as shown specifically in 530c of FIG. 5C). Additionally, in the automatic case of step 520, generation may occur by actuating a button (as shown in button 520a in FIG. 5C), or may occur completely automatically. In either the manual or automatic case, the user may confirm, and then insert the replacement text in step 550. Additionally, the user may iterate through each of the possible replacements and manually modify each (whether they be automatic or manually generated) until satisfied with the final result at step 525.

Moreover, in one or more cases, the user may rewrite part of the text and, in substantially real time given a background running or pooling process, the possible replacements may regenerate automatically (as in step 520) and/or may be highlighted (step 530) and selectable in 540. In one or more cases, the user may roll back to the original template or draft. In either the case of manual selection or manual replacement using one of the replacements, the user may have a selectable panel, dropdown box, or other GUI, as shown in 540b of FIG. 5C.

Particularly with respect to FIG. 5C, the user clicks a “Share” button on a news website, which leads to a draft box that contains the title of the news article along with the URL. Then, the user clicks on the replacement tool, and the text of the draft post is processed as discussed throughout, as: the recognition module highlights the entities in the post which are the candidates for replacement; the replacement module processes prospective replacements for the recognized entities (which the the user may choose as the replacement(s)); and the presentation module processes the revised post and inserts it back into the draft box, now including the selected replacements.

To effectuate this process, the user may simply choose “Generate” (or a similar indicator), which has the replacement tool perform the replacement(s) immediately based on the top candidate for each recognized entity. The replacement tool my also automatically ensure not to overcrowd the post with less relevant replacement(s), and thus elects to replace just three out of four recognized entities in the illustration.

Of course, the user may also select part of the post that is not “highlighted” by the recognition module. In this case, the replacement tool may generate a list of candidates to replace (or correct) the selected text or phrase, and the user may select a candidate to complete edits, and then may insert the post back into the draft box.

As referenced throughout, the replacement module may also improve its ranking and suggested lists of replacements by learning from user selection and editing behaviors across a large number of users, and for each individual user. By tracking user replacement choices among the list of candidates, pseudo-relevance feedback enhances the relevance rankings over time.

That is, a first feedback may stem from user selection of text for replacement, and selection of a replacement for that text from the ranked list. In the former, a user's selection of a substring in a post that the recognition tool may have not discovered as a good candidate for replacement, either completely or partially, is an indication that the text may be an important entity mention. Likewise, the higher percentage of frequency of selection of a particular selected replacement or replacements is a clear indication of the temporal relevance of certain text (or certain replacements), such as may be tracked geographically, socio-economically, or the like.

Further feedback from new selections also improves the entity recognition and recommended replacement processes. A user's selection (or not) of an entry in the ranked list is a feedback on the relevance of that entity and that entry, both to that individual user and globally. That is, repeated selection by a single user or small group of users of entities and replacements outside the recognition and/or ranking algorithms is indicative of the need to modify the recognition and/or ranking algorithm for that individual and/or for the group. Repeated selection by large numbers of users of entities for replacement or lower ranked replacements is feedback indicative of the need for global modification across all users of the recognition and/or ranking algorithms.

The algorithm adjustments, on an individual, small, or large scale, may use this feedback information to adjust the query weights, or add or remove query terms, or adjust factor categories, or adjust factor weights, or to use other criteria to improve the query representation when retrieving suitable mentions for replacement, and/or when ranking prospective replacements. This dynamic feedback loop ensures a continually evolving and improved, and even a personalized, experience for users.

The replacement tool thereby improves its ranking and suggested lists of edits by learning from user-editing behavior, in part by tracking user replacement choices among the list of candidates, a method inspired from pseudo-relevance feedback. The feedback may also come by user selection of unrecognized text to replace, as well as the selection of lower-ranked replacement(s) from the ranked list. Simply put, a user's selection for a list of possible replacements of a substring in a post that the recognition module did not discover, either completely or partially, is an indication that this actually may be an important entity mention to recognize in the future, either globally (if flagged by at least a predetermined number of other users), or at least to this user, going forward.

A user's selection (or not) of a proposed replacement entry in the ranked list is also feedback on the rank scoring of that entry. The replacement tool may use this information to adjust query factors, factor weights, and/or to add or remove query terms, factors, or weights, or to use other criteria to improve the query representation when ranking replacements for a recognized mention. This dynamic feedback loop ensures a continually evolving and personalized experience for users.

In some aspects of the present disclosure, software, such as in the form of tools, modules, and sub-modules, executing the instructions provided herein may be stored in a non-transitory manner on a computer-readable medium, wherein the software performs some or all of the steps of the present disclosure when executed by a processor.

Aspects of the disclosure relate to algorithms executed in computer software. Although certain embodiments may be described as written in particular programming languages, or executed on particular manner and/or by operating systems or computing platforms, it is understood that the system and method of the present disclosure is not limited to any particular computing language, platform, or combination thereof. Indeed, software executing the algorithms described herein may be written in any programming language known in the art, compiled, or interpreted, including but not limited to C, C++, C #, Objective-C, Java, JavaScript, MATLAB, Python, PHP, Perl, Ruby, or Visual Basic. It is further understood that elements of the present disclosure may be executed on any acceptable computing platform, including but not limited to a server, a cloud instance, a workstation, a thin client, a mobile device, an embedded microcontroller, a television, or any other suitable computing device known in the art.

Parts of this disclosure are described as software running on a computing device. Although software described herein may be disclosed as operating on one particular computing device (e.g. a mobile device, dedicated server or a workstation), it is understood that software is intrinsically portable and that most software running on any dedicated device or server may also be run, for the purposes of the present disclosure, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this disclosure are described as communicating over a variety of wireless or wired computer networks. For the purposes of this disclosure, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the disclosure may be implemented over a Virtual Private Network (VPN).

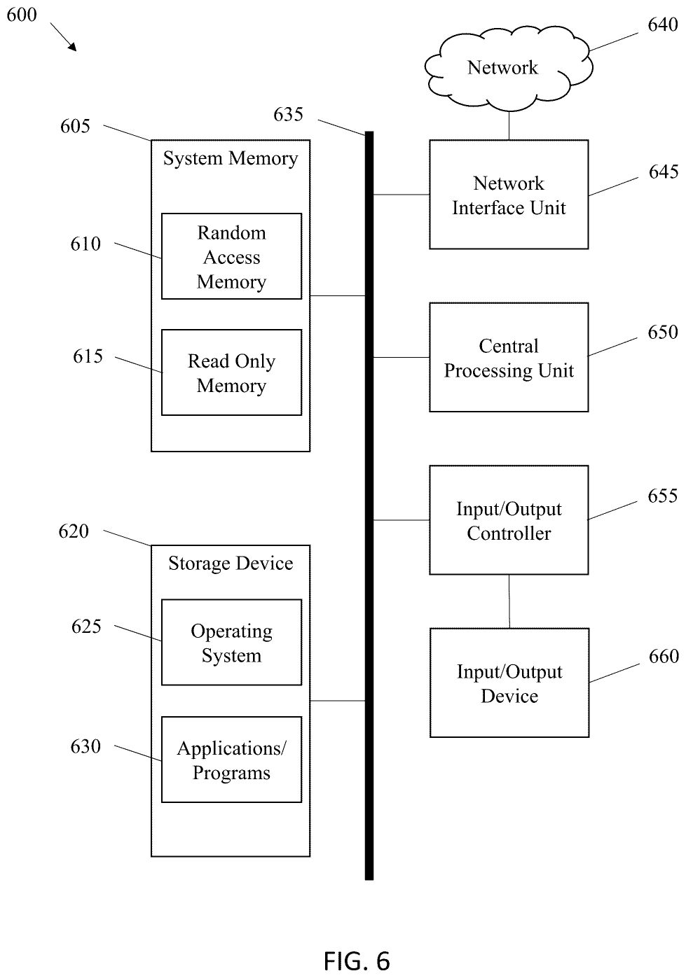

FIG. 6 and the following discussion are intended to provide a brief, general description of a suitable computing environment in which the disclosure may be implemented. While the disclosure is described above in the general context of program tools, modules and submodules that execute in conjunction with an application (or “app”) program that runs on an operating system on a computer, those skilled in the art will recognize that the disclosure may also be implemented in combination with other program modules.

Generally, program modules include routines, submodules, programs, components, data structures, and other types of structures that perform particular tasks or implement particular abstract data types. Moreover, those skilled in the art will appreciate that the disclosure may be practiced with other computer system configurations, including hand-held devices, multiprocessor systems, microprocessor-based or programmable consumer electronics, minicomputers, mainframe computers, and the like. The disclosure may also be practiced in distributed computing environments where tasks are performed by remote processing devices that are linked through a communications network. In a distributed computing environment, program modules may be located in both local and remote memory storage devices.

FIG. 6 depicts an illustrative computer architecture for a computer 600 for practicing the various embodiments of the disclosure. The computer architecture shown illustrates a conventional personal computer, including a central processing unit 650 (“CPU”), a system memory 605, including a random-access memory 610 (“RAM”) and a read-only memory (“ROM”) 615, and a system bus 635 that couples the system memory 605 to the CPU 650. A basic input/output system containing the basic routines that help to transfer information between elements within the computer, such as during startup, is stored in the ROM 615. The computer 600 further includes a storage device 620 for storing an operating system 625, application/program 630, and data.

The storage device 620 is connected to the CPU 650 through a storage controller (not shown) connected to the bus 635. The storage device 620 and its associated computer-readable media, provide non-volatile storage for the computer 600. Although the description of computer-readable media contained herein refers to a storage device, such as a hard disk or CD-ROM drive, it should be appreciated by those skilled in the art that computer-readable media can be any available media that can be accessed by the computer 600.

By way of example, and not to be limiting, computer-readable media may comprise computer storage media. Computer storage media includes volatile and non-volatile, removable, and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the disclosure, the computer 600 may operate in a networked environment using logical connections to remote computers through a network 640, such as TCP/IP network such as the Internet or an intranet. The computer 600 may connect to the network 640 through a network interface unit 645 connected to the bus 635. It should be appreciated that the network interface unit 645 may also be utilized to connect to other types of networks and remote computer systems.

The computer 600 may also include an input/output controller 655 for receiving and processing input from a number of input/output devices 660, including a keyboard, a mouse, a touchscreen, a camera, a microphone, a controller, a joystick, or other type of input device. Similarly, the input/output controller 655 may provide output to a display screen, a printer, a speaker, or other type of output device. The computer 600 can connect to the input/output device 660 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 620 and RAM 610 of the computer 600, including an operating system 625 suitable for controlling the operation of a networked computer. The storage device 620 and RAM 610 may also store one or more applications/programs/tools 630. In particular, the storage device 620 and RAM 610 may store an application/program 630 for providing a variety of functionalities to a user. For instance, the application/program 630 may comprise one or many types of programs. According to an embodiment of the present disclosure, the application/program 630 comprises a multiple functionality software application for providing the disclosed text recognition, replacement, and presentation.

While this disclosure has been disclosed with reference to specific embodiments, it is apparent that other embodiments and variations of this disclosure may be devised by others skilled in the art without departing from the true spirit and scope of the disclosure.

What is claimed is:

1. A computer readable medium storing non-transitory instructions that, when executed by a processor, cause the processor to perform the operations comprising:
recognizing entity text in an online posting comprising a plurality of substrings;
wherein the plurality of substrings comprises a subset of candidate strings;
wherein the subset of candidate strings comprises at least a first candidate string;
wherein the recognizing comprises determining a first entity corresponding to the first candidate string;
mapping the first entity to a first set of one or more prospective replacement texts;
ranking the prospective replacement texts based on a plurality of weighted factors; and
reconstructing the online posting, wherein the reconstructing comprises replacing the first candidate string with a higher ranked one of the prospective replacement texts relative to the rankings of other ones of the prospective replacement texts.

2. The nontransitory computer readable medium of claim 1, wherein the replacing the first candidate string comprises manual replacing;
prior to the manual replacing:
displaying a selectable panel comprising the first set of one or more prospective replacement texts corresponding to the first candidate string; and
receiving a user selection of the highly ranked one of the one or more prospective replacement texts from the selectable panel.

3. The nontransitory computer readable medium of claim 2, wherein the first set of the one or more prospective replacement texts comprise a hashtag, a mention, a user handle, an image, a hyperlink, or a meme.

4. The nontransitory computer readable medium of claim 2, wherein the subset of candidate strings further comprises a second candidate string;
wherein the recognizing further comprises determining a second entity corresponding to the second candidate string;
wherein mapping further comprises mapping the second entity to a second set of one or more prospective replacement texts; and
wherein reconstructing further comprises automatically replacing the second candidate string with a second prospective replacement texts of the second set of one or more prospective replacement texts.

5. The nontransitory computer readable medium of claim 4, wherein automatically replacing the second candidate string does not include displaying.

6. The nontransitory computer readable medium of claim 1, wherein the replacing the first candidate string comprises automatic replacing.

7. The nontransitory computer readable medium of claim 1, wherein the recognizing comprises an entity detector to determine the first entity, wherein the entity detector comprises an encoder to determine the first entity.

8. The nontransitory computer readable medium of claim 7, wherein the encoder to determine the first entity comprises a bidirectional encoder.

9. The nontransitory computer readable medium of claim 1, wherein the recognizing comprises an entity detector to determine the first entity, wherein the entity detector comprises named entity recognition to determine the first entity.

10. The nontransitory computer readable medium of claim 1, wherein mapping the first entity to a first set of one or more prospective replacement texts comprises a character level algorithm.

11. The nontransitory computer readable medium of claim 10, wherein the character level algorithm comprises a character-level N-grams TF-IDF algorithm.

12. The nontransitory computer readable medium of claim 1, wherein mapping the first entity to the first set of one or more prospective replacement texts comprises a hybrid retrieval.

13. The nontransitory computer readable medium of claim 12, wherein the hybrid retrieval comprises a bag-of-words retrieval function.

14. The nontransitory computer readable medium of claim 12, wherein the hybrid retrieval comprises nearest-neighbor search associated with entities which comprise the first entity.

15. The nontransitory computer readable medium of claim 14, wherein the nearest-neighbor search is associated with a number (k), wherein the number (k) of the nearest-neighbor search sets the one or more prospective replacement texts.

16. A system comprising:
one or more processors;
a memory storing instructions that, when executed by the one or more processors, cause the one or more processors to perform the operations comprising:
recognizing entity text in an online posting comprising a plurality of substrings;
wherein the plurality of substrings comprises a subset of candidate strings;
wherein the subset of candidate strings comprises at least a first candidate string;
wherein the recognizing comprises determining a first entity corresponding to the first candidate string;
mapping the first entity to a first set of one or more prospective replacement texts;
ranking the prospective replacement texts based on a plurality of weighted factors; and
reconstructing the online posting, wherein the reconstructing comprises replacing the first candidate string with a higher ranked one of the prospective replacement texts relative to the rankings of other ones of the prospective replacement texts.

17. The system of claim 16,
wherein the replacing the first candidate string comprises manual replacing;
prior to the manual replacing:
displaying a selectable panel comprising the first set of one or more prospective replacement texts corresponding to the first candidate string; and
receiving a user selection of the highly ranked one of the one or more prospective replacement texts from the selectable panel.

18. A method comprising:
recognizing entity text in an online posting comprising a plurality of substrings;
wherein the plurality of substrings comprises a subset of candidate strings;
wherein the subset of candidate strings comprises at least a first candidate string;
wherein the recognizing comprises determining a first entity corresponding to the first candidate string;
mapping the first entity to a first set of one or more prospective replacement texts;
ranking the prospective replacement texts based on a plurality of weighted factors; and
reconstructing the online posting, wherein the reconstructing comprises replacing the first candidate string with a higher ranked one of the prospective replacement texts relative to the rankings of other ones of the prospective replacement texts.

19. The method of claim 18,
wherein the replacing the first candidate string comprises manual replacing;
prior to the manual replacing:
displaying a selectable panel comprising the first set of one or more prospective replacement texts corresponding to the first candidate string; and
receiving a user selection of the highly ranked one of the one or more prospective replacement texts from the selectable pane

20. The method of claim 19, wherein the first set of the one or more prospective replacement texts comprise a hashtag, a mention, a user handle, an image, a hyperlink, or a meme.
